(19) United States
(12) Patent Application Publication
(10) Pub. No.: US 2004/0185206 A1
(43) Pub. Date: Sep. 23, 2004

(54) Composite material

(75) Inventor: Kurt-Robert Kappeler, Hanau (DE)

Correspondence Address: BURNS DOANE SWECKER & MATHIS L L P, POST OFFICE BOX 1404, ALEXANDRIA, VA, 22313-1404, US

(73) Assignee: Veritas AG, Gelnhausen (DE)

(21) Appl. No.: 10/767,269

(22) Filed: Jan. 30, 2004

(30) Foreign Application Priority Data
Feb. 13, 2003 (DE) 103 06 072.3

(51) Int. Cl. B65D 1/00; B32B 1/08

(52) U.S. Cl. 428/36.91

(57) ABSTRACT

The present invention relates to a composite material, which is preferably made of extrudable materials, said composite material comprising a first layer and at least one second layer, which are connected to one another and which are opaque, and further comprising at least one marking section, and to a method of producing a composite material according to the present invention.

The present invention relates to a composite material, which is preferably made of extrudable materials, said composite material comprising a first layer and at least one second layer, which are connected to one another and which are opaque, and further comprising at least one marking section.

A composite material of this type is known from the prior art. This composite material is e.g. used for producing fuel hoses for motor vehicles. Making use of pigmented ink-jet printer ink, the hoses have applied thereto marks that are visually recognizable. For applying the ink, ink-jet printers or tampon printers are used, by way of example. The information printed on is e.g. the manufacturing date or the material used.

Up to now, it is difficult to trace back individual process steps, since only the last layer of the composite material can be marked with a stamp. It is impossible to print e.g. the manufacturing date on the layers located below said last layer. The production of the lower layers may perhaps have taken place already a few days before the application of the uppermost layer. Faults occurring in the inner layers are therefore difficult to reconstitute. Furthermore, it is difficult to trace back individual process steps in the case of surfaces which should not be printed on or in the case of surfaces from which the ink has been removed from the surface, e.g. by abrasion.

It is the object of the present invention to improve a composite material of the type mentioned at the start, to improve in particular the retraceability of individual process steps and to allow a marking of products whose surface should not be printed on.

According to the present invention, this task is solved by a composite material of the type mentioned at the start, in which the marking section is arranged between the layers and adapted to be read making use of X rays.

This solution has the advantage that individual process steps can be traced back. For example, the manufacturing date and the processing data, respectively, can be applied to each layer. In addition, it is also possible to mark products whose surface should not be printed on. Furthermore, the individual process steps can still be traced back, when the ink applied to the surface has already been abraded. By applying the marking section between the layers, said marking section can additionally protected against abrasion in an effective manner.

It may be of advantage when the composite material is a multi-layer hose, since the properties of e.g. a fuel hose in a motor vehicle can be improved in this way.

It may also be advantageous when at least one layer is made of an elastomer. This will increase the flexibility still further.

According to a preferred embodiment, the elastomer can be a rubber, whereby the durability can be improved still further.

When the rubber is an ethylene acrylate rubber, the durability can be increased still further.

Furthermore, it may of advantage, when the marking section is formed by an ink. In this way, the mark can be applied more easily and the thickness of the layer will only be increased to an insignificant extent.

In addition, it may prove to be advantageous when the ink contains an iodine compound. The readability by application of X rays can be improved still further in this way.

It may also be of advantage when the iodine compound is iopamidole, since this will improve the readability by application of X rays once more.

It may also be advantageous when the ink contains a potassium iodide, since this will lead to another improvement of the readability by application of X rays.

It may also be of advantage when the ink contains potassium bromide. Also this will lead to another improvement of the readability by application of X rays.

According to an advantageous further development of the present invention, the ink can be applicable to the hose by means of a printer, whereby the application of the marks is facilitated still further.

It may also prove to be advantageous when the printer is an ink-jet printer. This will facilitate the application of the ink still further.

In addition, it may prove to be advantageous when the printer is a tampon printer. In this way, it will be possible to apply the ink even more easily.

It may also be of advantage when the marking sections are provided in longitudinally spaced relationship with one another in a recurring mode of arrangement. This will allow reading of the mark even when the hose has been divided into a plurality of sections.

Furthermore, a method for producing a composite material according to the present invention is claimed, which comprises the steps of producing the first opaque layer, preferably by means of extrusion, applying then the marking sections, which are adapted to be read making use of X rays, and applying subsequently, preferably by means of extrusion, at least one second opaque layer on top of said marking sections.

This solution has the advantage that the retraceability of individual process steps is facilitated. Individual layers of the composite material can be marked by applying e.g. the date thereto. In addition, it is possible to mark products whose surface should not be printed on.

It may be advantageous to apply an adhesion promoter between said first and said second layer. The adhesion between the layers can thus be improved still further.

It may also be of advantage when the marking sections are applied by printing onto the layer. The application of the marking sections can be facilitated still further in this way. In addition, the thickness of the layer will only be increased to a very little extent by the application of the marking sections.

It may also prove to be advantageous when the marking sections extend in the longitudinal direction. This will permit a retracing of individual process steps even when the hose has been divided into individual sections.

In the following, the present invention will be explained in detail making reference to an embodiment and the associated drawing, in which

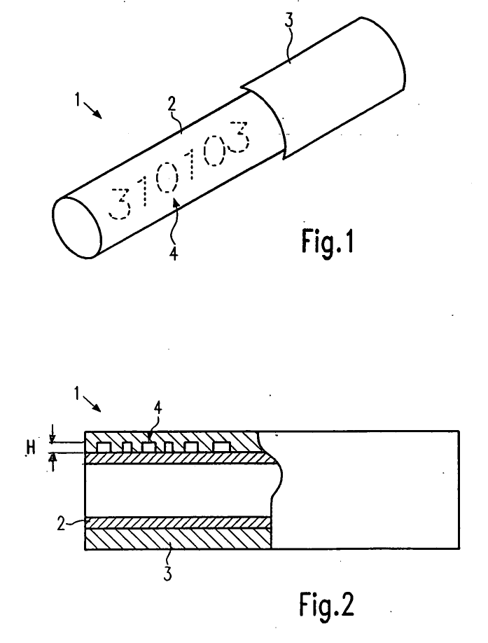

FIG. 1 shows a sectional view of a composite material according to the present invention, and

FIG. 2 shows a side view of the composite material of FIG. 1.

FIG. 1 shows a multi-layer hose 1 comprising a first layer 2 and a second layer 3. The two layers 2, 3 are opaque and connected to one another. In addition, a marking section 4 is shown, which is arranged between the layers 2, 3 and which is adapted to be read making use of X-rays. In the example shown, the mark indicates the date. Other characteristics can, however, be applied as well, such as the material, a production number or the like.

In this way it is possible to trace back individual process steps. In addition, products can be marked whose surface should not be printed on. Furthermore, tracing back will even be possible when a mark applied to the outermost layer has already been abraded. Due to its arrangement between the layers 2, 3, the marking section 4 can, in addition, effectively be protected against abrasion.

It is also possible to apply a plurality of recurring marking sections 4 in longitudinally spaced relationship with one another, whereby tracing back will also be possible when the hose 1 has already been separated into several subsections.

At least one layer 2, 3 of the hose 1 is made of an elastomer, preferably a rubber. In this case an ethylene acrylate rubber is preferably used.

FIG. 2 shows a side view of the hose 1 of FIG. 1.

Also in this case, the layers 2 and 3 of the hose 1 are clearly visible.

In addition, the height H of the marking section 4 is clearly visible.

The hose 1 may also comprise more than two layers 2, 3. Each of the layers can have arranged thereon marking sections 4 which are adapted to be read making use of X rays. In addition, marks that are visually recognizable can be applied to the outermost layer 3; these marks are not shown.

When several layers 2, 3 have applied thereto marking sections 4 which are adapted to be read making use of X rays, it will be advantageous when these marking sections 4 are displaced relative to one another. The readability of the marking sections 4 can be improved in this way.

The marking section 4 is normally formed by an ink 4. Ink-jet printer ink, which has various substances admixed thereto, is preferably used for this purpose. The ink 4 contains an iodine compound, normally iopamidole, which is colourless, so that the marking sections 4 provided between the layers are adapted to be read making use of X rays. Alternatively, also potassium iodide and potassium bromide proved to be useful as additions to the ink. The ink 4 absorbs X rays. The chemical name of iopamidole is

(S)—N,N′-bis[2-hydroxy-1-(hydroxymethyl)ethyl]-2,4,6-triiod-5-lactamidoisophtalamid

The application of the ink 4 to layer 2 has the advantage that the thickness of layer 2 is only increased to a very little extent by the ink 4.

The ink 4 is normally applied to the hose 1 by means of a printer. Printers which are suitable for this purpose are e.g. ink-jet printers, tampon printers, offset printers, laser printers, etc.

In the following, the mode of operation of a method for producing a composite material 1 will be explained in detail.

To begin with, the first opaque layer 2 is produced, preferably by means of extrusion. Subsequently, the marking sections 4, which are adapted to be read making use of X rays, are applied. Following this, a second opaque layer 3 is applied, preferably by means of extrusion. This layer can again be provided with marking sections 4 and a further layer, which is not shown, can then be extruded onto said second layer. This process can be repeated in accordance with the number of layers desired.

Between the layers 2, 3 an adhesion promoter is applied so as to allow a better adhesion between said layers 2, 3. It is also imaginable to use no adhesion promoter between the layers 2, 3, but the use of an adhesion promoter will improve adhesion between said layers 2, 3.

The marking sections 4 are applied to the layer or layers by printing onto said layer or layers an ink 4 which, as has already been explained hereinbefore, contains an iodine compound. Printers which are suitable to be used for this purpose are laser printers, tampon printers, ink-jet printers etc.

It will be advantageous when the marking sections 4 extend in the longitudinal direction of the hose 1. The marking sections 4 can in this way also be read when the hose 1 has been divided into several parts. Hence, individual process steps can also be traced back in the case of subsections of the hose 1. When a plurality of marking sections 4 is applied to different layers, it will be advantageous to arrange the marking sections 4 of the individual layers such that they are displaced relative to one another, so as to increase the readability still further.

Making use of a pigmented ink-jet printer ink, visually recognizable marks, which are not shown here, can additionally be applied to the uppermost layer 3 in the usual way.

When the hose 1 is exposed to X rays passing therethrough, the marking sections 4, which are provided between the layers 2, 3, can be read.

By means of the composite material 1 according to the present invention and the disclosed method for producing a composite material 1 according to the present invention, individual process steps can be traced back. It is even possible to trace back preceding processes, i.e. layers which are arranged below the uppermost layer can be marked. The marking sections 4 applied can be read making use of X rays. In addition, also products can be marked whose surface should not be printed on.

In view of the fact that the marking sections 4 are located between the layers, the risk that the ink 4 may be removed, e.g. by abrasion, does not exist.

The composite material according to the present invention and the presented method for producing a composite material according to the present invention are suitable to be used not only for hoses, as has been described hereinbefore, but also for plastic materials, elastomers and other multi-layer products.

1. A composite material, which is preferably made of extrudable materials, comprising a first layer (2) and at least one second layer (3), which are connected to one another and which are opaque, and further comprising at least one marking section (4), characterized in that the marking section (4) is arranged between the layers (2, 3) and adapted to be read making use of X rays.

2. A composite material according to claim 1, characterized in that the composite material (1) is a multi-layer hose (1).

3. A composite material according to at least one of the preceding claims, characterized in that at least one of said layers (2, 3) is made of an elastomer.

4. A composite material according to at least one of the preceding claims, characterized in that the elastomer is a rubber.

5. A composite material according to at least one of the preceding claims, characterized in that the rubber is an ethylene acrylate rubber.

6. A composite material according to at least one of the preceding claims, characterized in that the marking section (4) is formed by an ink (4).

7. A composite material according to at least one of the preceding claims, characterized in that the ink (4) contains an iodine compound.

8. A composite material according to at least one of the preceding claims, characterized in that the iodine compound is iopamidole.

9. A composite material according to at least one of the preceding claims, characterized in that the ink contains potassium iodide.

10. A composite material according to at least one of the preceding claims, characterized in that the ink contains potassium bromide.

11. A composite material according to at least one of the preceding claims, characterized in that the ink (4) is applicable to the hose (1) by means of a printer.

12. A composite material according to at least one of the preceding claims, characterized in that the printer is an ink-jet printer.

13. A composite material according to at least one of the preceding claims, characterized in that the printer is a tampon printer.

14. A composite material according to at least one of the preceding claims, characterized in that the marking sections (4) are provided in longitudinally spaced relationship with one another in a recurring mode of arrangement.

15. A method for producing a composite material (1) according to claims 1 to 14, characterized in that the first opaque layer (2) is produced, preferably by means of extrusion, that the marking sections (4), which are adapted to be read making use of X rays, are then applied, and that, subsequently, at least one second opaque layer (3) is applied on top of said marking sections (4), preferably by means of extrusion.

16. A method according to claim 15, characterized in that an adhesion promoter is applied between said first (2) and said second layer (3).

17. A method according to claim 15 or 16, characterized in that the marking sections (4) are applied by printing onto the layer (2).

18. A method according to at least one of the claims 15 to 17, characterized in that the marking sections (4) extend in the longitudinal direction.
